(19) United States
(12) Patent Application Publication
(10) Pub. No.: US 2018/0041973 A1
(43) Pub. Date: Feb. 8, 2018

(54) Estimating Joint CSI based on Multiple CSI Reports

(71) Applicant: Telefonaktiebolaget LM Ericsson (publ), Stockhom (SE)

(72) Inventors: Sebastian Faxér, Järfälla (SE); Niklas Wernersson, Kungsängen (SE)

(21) Appl. No.: 15/554,182

(22) PCT Filed: Feb. 1, 2016
(86) PCT No.: PCT/SE2016/050068

§ 371 Date: Aug. 28, 2017

Related U.S. Application Data
(60) Provisional application No. 62/109,717, filed on Jan. 30, 2015.

(51) Int. Cl. H04W 52/32; H04B 7/0417; H04L 5/00

(52) U.S. Cl. CPC H04W 52/325; H04L 5/0048; H04L 5/0053; H04B 7/0417; H04B 7/0639

(57) ABSTRACT

The present disclosure pertains to a method for operating a network node (100) for a wireless communication network, the method comprising providing CSI-RS signaling, the method further comprising signaling a power boost indication for the CSI-RS signaling. The disclosure also pertains to related devices and methods.

### TECHNICAL FIELD

This disclosure pertains to wireless communication technology, in particular to measurement reports (e.g., CSI reports) respectively carrier aggregation scenarios.

### BACKGROUND

The use of multi-antenna arrays with increasing numbers of antennas for wireless communication system is becoming ubiquitous, in particular on the network side, e.g. eNodeBs. While such arrays provide advantages in regards to beam-forming possibilities, efficiency and transmission quality, they also provide additional challenges.

### SUMMARY

It is an object of the present disclosure to provide approaches allowing reliable CSI-processes in particular in scenarios with multi-antenna arrays.

Accordingly, there is described a method for operating a network node for a wireless communication network, the method comprising providing CSI-RS signaling, the method further comprising signaling a power boost indication for the CSI-RS signaling.

Moreover, a network node for a wireless communication network is proposed, the network node being adapted for providing CSI-RS signaling, the network node further being adapted for a boost indication module for signaling a power boost indication for the CSI-RS signaling.

Alternatively or additionally, a network node for a wireless communication network is described. The network node is adapted to configure a terminal with a power boost indication for CSI-RS signaling provided by the network node.

There is also provided a method for operating a network node for a wireless communication network, the method comprising configuring a terminal with a power boost indication for CSI-RS signaling provided by the network node.

Moreover, there is disclosed a method for operating a terminal for a wireless communication network, the method comprising determining CSI-RS feedback based on a power boost indication for the CSI-RS signaling received from and/or configured by a network node.

A terminal for a wireless communication network is considered. The terminal is adapted for determining CSI-RS feedback based on a power boost indication for the CSI-RS signaling received from and/or configured by a network node.

Additionally, there is disclosed a storage medium adapted to store instructions executable by control circuitry, the instructions causing the control circuitry to carry out and/or control any one of the methods disclosed herein when executed by the control circuitry.

The described approaches allow compensating of power level (power boost) differences between CSI-RS signaling and other signaling using the multi-antenna arrays, facilitating more correct CSI feedback and more efficient operation in the network.

### BRIEF DESCRIPTION OF THE DRAWINGS

The drawings are provided to illustrate concepts and approaches of the disclosure and are not intended as limitation. The drawings comprise:

FIG. 1, showing an illustration of a two-dimensional antenna array of cross-polarized antenna elements;

FIG. 2, showing a transmission structure of precoded spatial multiplexing mode in LTE;

FIG. 3, showing an 8×4 antenna with corresponding CSI-RSs;

FIG. 4, showing a 10×4 antenna with corresponding CSI-RSs;

FIG. 5, schematically showing a terminal; and

FIG. 6, schematically showing a network node.

### DETAILED DESCRIPTION

Note that although terminology from 3GPP LTE has been used in this disclosure to exemplify the concepts, this should not be seen as limiting the scope of the disclosure to only the aforementioned system. Other wireless systems, including WCDMA, WiMax, UMB and GSM, may also benefit from exploiting the ideas covered within this disclosure.

Also note that terminology such as eNodeB and UE should be considering non-limiting and does in particular not imply a certain hierarchical relation between the two; in general “eNodeB” could be considered as device 1 and “UE” device 2, and these two devices communicate with each other over some radio channel. Herein, it is focused on wireless transmissions in the downlink, but the approach is equally applicable in the uplink.

Codebook-based precoding is discussed in the following.

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

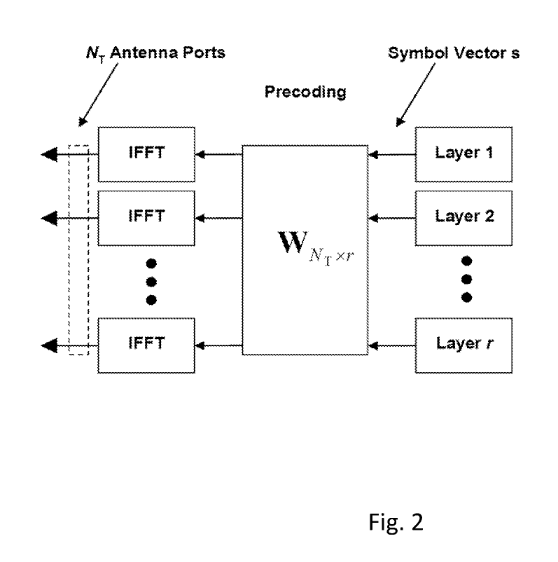

The LTE standard is currently evolving with enhanced MIMO support. A core component in LTE is the support of MIMO antenna deployments and MIMO related techniques. Currently LTE-Advanced supports an 8-layer spatial multiplexing mode for 8 Tx antennas with channel dependent precoding. The spatial multiplexing mode is aimed for high data rates in favorable channel conditions. An illustration of the spatial multiplexing operation is provided in FIG. 2.

As seen, the information carrying symbol vector s is multiplied by an N_{T}×r precoder matrix w, which serves to distribute the transmit energy in a subspace of the N_{T} (corresponding to N_{T} antenna ports) dimensional vector space. The precoder matrix is typically selected from a codebook of possible precoder matrices, and typically indicated by means of a precoder matrix indicator (PMI), which specifies a unique precoder matrix in the codebook for a given number of symbol streams. The r symbols in s each correspond to a layer and r is referred to as the transmission rank. In this way, spatial multiplexing is achieved since multiple symbols can be transmitted simultaneously over the same time/frequency resource element (TFRE). The number of symbols r is typically adapted to suit the current channel properties. LTE uses OFDM in the downlink (and DFT precoded OFDM in the uplink) and hence the received N_{R}×1 vector yₙ for a certain TFRE on subcarrier n (or alternatively data TFRE number n) is thus modeled by

yₙ=HₙWₛ_{ₙ}+eₙ

where eₙ is a noise/interference vector obtained as realizations of a random process. The precoder, can be a wideband precoder, which is constant over frequency, or frequency selective.

The precoder matrix is often chosen to match the characteristics of the N_{R}×N_{T} MIMO channel matrix H, resulting in so-called channel dependent precoding. This is also commonly referred to as closed-loop precoding and essentially strives for focusing the transmit energy into a subspace which is strong in the sense of conveying much of the transmitted energy to the UE. In addition, the precoder matrix may also be selected to strive for orthogonalizing the channel, meaning that after proper linear equalization at the UE, the inter-layer interference is reduced.

The transmission rank, and thus the number of spatially multiplexed layers, is reflected in the number of columns of the precoder. For efficient performance, it is important that a transmission rank that matches the channel properties is selected.

Channel State Information Reference Symbols (CSI-RS) are discussed in the following.

In LTE Release-10, a new reference symbol sequence was introduced for the intent to estimate channel state information, the CSI-RS. The CSI-RS provides several advantages over basing the CSI feedback on the common reference symbols (CRS) which were used, for that purpose, in previous releases. Firstly, the CSI-RS is not used for demodulation of the data signal, and thus does not require the same density (i.e., the overhead of the CSI-RS is substantially less). Secondly, CSI-RS provides a much more flexible means to configure CSI feedback measurements (e.g., which CSI-RS resource to measure on can be configured in a UE specific manner).

By measuring on a CSI-RS a UE can estimate the effective channel the CSI-RS is traversing including the radio propagation channel and antenna gains. In more mathematical rigor this implies that if a known CSI-RS signal x is transmitted, a UE can estimate the coupling between the transmitted signal and the received signal (i.e., the effective channel). Hence if no virtualization is performed in the transmission, the received signal y can be expressed as

y=Hx+e

and the UE can estimate the effective channel H.

Up to eight CSI-RS ports can be configured, that is, the UE can estimate the channel from up to eight transmit antennas.

Related to CSI-RS is the concept of zero-power CSI-RS resources (also known as a muted CSI-RS) that are configured just as regular CSI-RS resources, so that a UE knows that the data transmission is mapped around those resources. The intent of the zero-power CSI-RS resources is to enable the network to mute the transmission on the corresponding resources in order to boost the SINR of a corresponding non-zero power CSI-RS, possibly transmitted in a neighbor cell/transmission point. For Rel-11 of LTE a special zero-power CSI-RS was introduced that a UE is mandated to use for measuring interference plus noise. A UE can assume that the TPs of interest are not transmitting on the zero-power CSI-RS resource, and the received power can therefore be used as a measure of the interference plus noise.

Based on a specified CSI-RS resource and on an interference measurement configuration (e.g. a zero-power CSI-RS resource), the UE can estimate the effective channel and noise plus interference, and consequently also determine which rank, precoder and transport format to recommend that best match the particular channel.

CSI-RS and corresponding signaling may generally be seen as representative of reference signaling (which may also be referred to as pilot signaling). Such reference signaling may be carried on and/or associated to a dedicated and/or shared channel (in particular, a logical or physical channel).

Implicit CSI Feedback is discussed in the following.

For CSI feedback LTE has adopted an implicit CSI mechanism where a UE does not explicitly report e.g., the complex valued elements of a measured effective channel, but rather the UE recommends a transmission configuration for the measured effective channel. The recommended transmission configuration thus implicitly gives information about the underlying channel state.

In LTE the CSI feedback is given in terms of a transmission rank indicator (RI), a precoder matrix indicator (PMI), and channel quality indicator(s) (CQI). The CQI/RI/PMI report can be wideband or frequency selective depending on which reporting mode that is configured. A user equipment may generally be adapted to receive, and/or receive and/or comprise a receiving module for receiving, CSI-RS signaling, e.g. from a network node or network. The user equipment may be adapted to provide (e.g., by transmitting), and/or provide and/or comprise a feedback module for providing, CSI feedback, in particular CSI feedback comprising RI and/or PMI and/or CQI. A network node, e.g. an eNodeB, may be adapted to provide (e.g. by transmitting), and/or provide and/or comprise a CSI providing module, CSI-RS signaling, e.g. to one or more than one terminals or UEs. It may be considered that a network node is adapted to receive, and/or receives and/or comprises a feedback receiving module, for receiving CSI feedback, e.g. from one or more terminals or UEs.

The RI corresponds to a recommended number of streams that are to be spatially multiplexed and thus transmitted in parallel over the effective channel. The PMI identifies a recommended precoder (in a codebook which contains precoders with the same number of rows as the number of CSI-RS ports) for the transmission, which relates to the spatial characteristics of the effective channel. The CQI represents a recommended transport block size (i.e., code rate). There is thus a relation between a CQI and an SINR of the spatial stream(s) over which the transport block is transmitted.

An exemplary CSI Process is discussed in the following.

In LTE Release 11, CSI processes are defined such that each CSI process is associated with a CSI-RS resource and a CSI-IM resource. A UE in transmission mode 10 can be configured with one or more (up to three) CSI processes per serving cell by higher layers and each CSI reported by the UE corresponds to a CSI process. A UE may be configured with a RI-reference CSI process for any CSI process, such that the reported RI for the CSI process is the same as for the RI-reference CSI process. This configuration may be used to force a UE to report the same RI for several different interference hypotheses, even though another RI would be the best choice for some hypotheses. Furthermore, a UE is restricted to report PMI and RI within a precoder codebook subset configured for each CSI process by higher layer signaling. This configuration may also be used to force a UE to report a specific rank for a certain CSI process.

2D antenna arrays are discussed in the following.

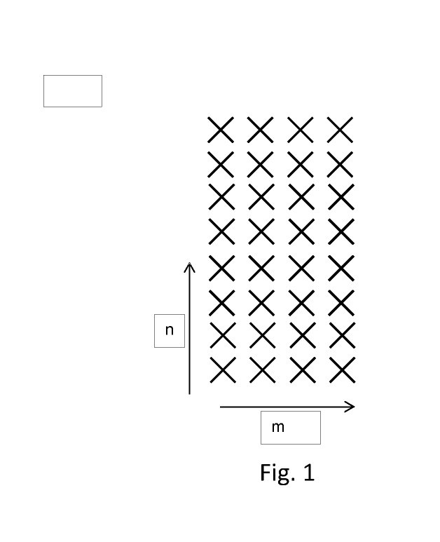

This disclosure in particular concerns two-dimensional antenna arrays where each antenna element has an independent phase and amplitude control, thereby enabling beamforming in both in the vertical and the horizontal dimension. Such antenna arrays may be (partly) described by the number of antenna columns corresponding to a horizontal dimension or extension [symbol] ₖ, the number of antenna rows corresponding to a vertical dimension or extension [symbol] ᵥ and the number of dimensions corresponding to different polarizations [symbol] ₚ. The total number of antennas is thus [symbol] = [symbol] ₖ [symbol] ᵥ [symbol] ₚ. An example of an antenna where [symbol] ₖ=8 and [symbol] ᵥ=4 is illustrated in FIG. 1. It furthermore consist of cross-polarized antenna elements meaning that [symbol] _{V}=2. Such an antenna is denoted as an 8×4 antenna array with cross-polarized antenna elements. The horizontal and vertical directions may be chosen arbitrarily (e.g., the horizontal does not necessarily have to be parallel to a geographically horizontal line and/or parallel to the ground), in particular such that they are orthogonal to each other.

It should be pointed out that the concept of an antenna element is nonlimiting in the sense that it can refer to any virtualization (e.g., linear mapping) of the physical antenna elements. For example, pairs of physical sub-elements could be fed the same signal, and hence share the same virtualized antenna port. Hence, the terms “antenna element”, “antenna port” or simply “port” should be considered interchangeable in this document.

Precoding may be interpreted as multiplying the signal with different beamforming weights for each (virtual) antenna element prior to transmission. A typical approach is to tailor the precoder to the antenna form factor, i.e. taking into account [symbol] ₖ, [symbol] ᵥ and [symbol] ₚ when designing the precoder codebook.

A common approach when designing precoder codebooks tailored for 2D antenna arrays is to combine precoders tailored for a horizontal array and a vertical array respectively by means of a Kronecker product. This means that (at least part of) the precoder can be described as a function of

W_{H} [symbol] W_{P}

where W_{H} is a horizontal precoder taken from a (sub)-codebook X_{H} containing N_{H} codewords and similarly W_{V} is a vertical precoder taken from a (sub)-codebook containing N_{V} codewords. The joint codebook, denoted X_{H} [symbol] X_{V}, thus contains N_{H}·N_{V} codewords. The elements of X_{H} are indexed with k=0, . . . , N_{H}−1, the elements of X_{V} are indexed with l=0, . . . , N_{V}−1, and the elements of the joint codebook X_{H} [symbol] X_{V} are indexed with m=N_{V}·k+l meaning that m=0, . . . , N_{H}·N_{V}−1. The Kronecker product A [symbol] B between two matrices

$$A = [ \begin{matrix}{A}_{1 , 1} & … & {A}_{1 , M} \\ ⋮ & ⋱ & ⋮ \\ {A}_{N , 1} & … & {A}_{N , M}\end{matrix} ]$$

and B is defined as

$$A ⊗ B = [ \begin{matrix}{A}_{1 , 1} B & … & {A}_{1 , M} B \\ ⋮ & ⋱ & ⋮ \\ {A}_{N , 1} B & … & {A}_{N , M} B\end{matrix} ] ,$$

A scheme with separate horizontal and vertical CSI feedback is described in the following.

To acquire CSI feedback in the case where a 2D antenna array is used, one may use one CSI-RS per antenna element in order to enable the UE to fully estimate the MIMO channel matrix H and be able to calculate and feed back a PMI, CQI and RI reflecting knowledge of the full channel. However, this poses a problem since the LTE standard currently only supports a maximum of 8 CSI-RS ports. With the 8×4 antenna illustrated in the previous section, [symbol] = [symbol] ᵥ [symbol] ₖ [symbol] ₚ=8·4·2=64 CSI-RS ports would hence be required.

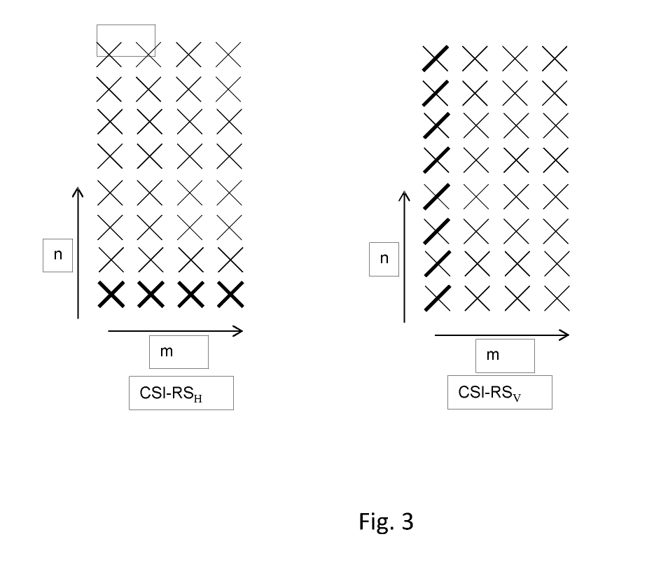

A solution to this problem is to use so called separate dimension feedback, meaning that two separate CSI processes are used to acquire CSI: one vertical CSI process and one horizontal CSI process. The vertical CSI-RS could be transmitted on antenna elements from a single column from the antenna array, as is illustrated in FIG. 3. Based on these vertical CSI-RS (which are denoted “V-CSI-RS”), the UE can estimate a partial channel matrix Hᵥ. Similarly, the horizontal CSI-RS (which are denoted “H-CSI-RS”) could be transmitted on a single row of the antenna array, such as is illustrated in FIG. 3. Based on said horizontal CSI-RS, the UE could then accordingly estimate another partial channel matrix H_{H}.

For each of these separate CSI processes, the UE selects and feeds back a PMI, CQI and RI indicating the CSI of the partial channels H_{V} and H_{H} respectively. That is, the eNodeB will receive two sets of CSI values. The eNodeB may then, based on PMI_{V} (indicating the precoder W_{V}) and PMI_{H} (indicating the precoder W_{H}) create a combined 2D precoder using a Kronecker product

W=W_{H} [symbol] Wₚ,

as discussed in the previous section. With this scheme, two-dimensional beamforming can be accomplished using the current LTE Rel-12 standard, i.e. without having to increase the number of CSI-RS ports or designing a new codebook.

A problem with the separate feedback scheme is that the reported CQI and RI values do not accurately reflect the CSI of the full channel H, since they have been calculated using the partial channels H_{V} and H_{H} respectively. It is not obvious how the eNodeB should decide upon a modulation and coding scheme (MCS) and a rank based upon these two partial feedback reports. Choosing MCS and rank may suboptimally lead to link adaptation errors which may spoil system performance.

There is described an approach to estimate a joint CQI and a joint RI from a set of multiple CSI-RS reports. Each CSI-RS process may for instance represent a separate dimension in a 2D antenna array such that one CSI-RS corresponds to vertical beamforming whereas another CSI-RS corresponds to horizontal beamforming.

This solution improves CQI and RI estimations in particular for MIMO systems with multiple antenna elements, leading to smaller link adaptation errors and increased system performance.

It is an open problem of how to accurately estimate CQI/PMI/RI reflecting the full MIMO channel based on CQI/PMI/RI:s from two separate CSI reports where each report only constitutes partial channel state information of the full channel state information. This disclosure proposes a method to estimate CQI/PMI/RI for the full channel based on this partial channel state information.

In one embodiment of the disclosure, two eight ports CSI-RS:s are transmitted from a 2D 8×4 antenna as illustrated in FIG. 3, the thicker antenna elements are assumed to be connected to CSI-RS antenna ports. Hence, CSI-RS_{H} corresponds to the horizontal domain of the antenna whereas CSI-RS_{V} corresponds to the vertical domain of the antenna. As previously pointed out, the eNodeB will receive, as feedback to this CSI-RS signaling, two sets of CSI values and based on PMI_{V} (corresponding to CSI-RS_{V} and thus indicating the precoder W_{V}) and PMI_{H} (corresponding to CSI-RS_{H} and thus indicating the precoder W_{H}), it may create a combined 2D precoder using a Kronecker product as

W=W_{H} [symbol] W_{V},

It should be noted that CSI-RS_{H} is transmitted on both polarizations whereas CSI-RS_{V} is transmitted on only one polarization. Hence, with such a setup, the reported rank of the CSI-RS_{V} could be fixed to one in the configuration of the CSI process.

The transmission rank would then be decided entirely by the CSI-RS_{H}.

The CSI reports corresponding to CSI-RS_{V} and CSI-RS_{H} will both be derived given a one dimensional beamforming gain in the sense that for, in the case of, CSI-RS_{H} there will be no beamforming gain in the vertical domain, since CSI-RS_{H} is transmitted only using one antenna row. However, the UE will receive a two-dimensional beamforming gain in the PDSCH transmission if all antenna rows are used.

Hence, both CQI_{V} and CQI_{H} (corresponding to CSI-RS_{V} and CSI-RS_{H}) will be derived without accounting for the two-dimensional beamforming gain. This will result in a too conservative SINR estimate, both for the vertical as well as the horizontal domain, which in turn will bias the UE to choose a lower transmission rank than what is optimal (typically a higher SINR is required in order to benefit from using a higher rank). Hence, with this simple setup the rank report (RI_{H}) from CSI-RS_{H} can be expected to be suboptimal and letting the eNodeB base the rank selection from this may lead to degraded performance.

In a variant, the rank report (RI_{H}) is corrected by indicating that the resource elements corresponding to the CSI-RS_{H} are less power boosted compared to the PDSCH resource elements.

There is disclosed a method for operating a network node, the method comprising providing, e.g. by the network node, CSI-RS signaling, e.g. to a terminal or UE, the method further comprising signaling a power boost indication for the CSI-RS signaling. A network node may be considered, the network node being adapted for, and/or comprising a CSI module for, providing CSI-RS signaling. The network node may be adapted for, and/or comprise a boost indication module for, signaling a power boost indication for the CSI-RS signaling. Alternatively or additionally, there may be considered a network node adapted to configure, and/or configure and/or comprise a configuring module for configuring, a terminal or UE with a power boost indication for CSI-RS signaling provided by the network node.

Generally (in addition to some or all of the above or independent thereof), a method for operating a network node may considered, comprising determining and/or reconstructing, e.g. by the network node, a full channel CSI, in particular CQI, based on partial channel CSI feedback information from a terminal or UE. There may be considered a network node adapted for, and/or comprising a CSI reconstruction module for, determining and/or reconstructing such full channel CSI. The partial channel CSI feedback may be as described above, e.g. transmitted by a corresponding user equipment or terminal, in particular based on a power boost indication. The CSI feedback may be feedback relating to CSI-RS and/or power boost indication transmitted by the network node to the terminal. Determining and/or reconstructing such full channel CSI may be based on at least one power compensation indication, e.g. one value for each partial channel and/or dimension of partial channels, which may be a power boost indication as described herein, e.g. a corresponding parameter Pc. Such determining and/or reconstructing may comprise determining and/or reconstructing CQI, PMI and/or RI, e.g. based on CQI values associated to the partial channels.

There is also disclosed a method for operating a terminal or UE, the method comprising determining, e.g. by the terminal or UE, CSI-RS feedback based on a power boost indication for the CSI-RS signaling received from and/or configured by a network node, which may be the network node the CSI-RS feedback is intended for and/or from which the CSI-RS is received. There may be considered a terminal or UE adapted for such determining and/or comprising a feedback determining module for such determining. Determining CSI-RS feedback may in particular comprise choosing rank and/or RI based on the power boost indication. The terminal or UE may transmit, and/or be adapted to transmit and/or comprise a transmitting module for transmitting, the CSI-RS feedback, e.g. to a network and/or the network node. It may be considered that the terminal or UE receives, and/or is adapted to receive and/or comprises a receiving module for receiving, CSI-RS signaling and/or a power boost indication, e.g. from a network and/or a network node.

The power boost indication may comprise at least one (or more) power boost indicator parameter Pc, which may indicate the ratio of PDSCH Energy Per Resource Element (EPRE) to CSI-RS EPRE; there may be different parameters for different dimensions/partial channels. Generally, a power boost indicator parameter may indicate a difference between power used for data transmission and power used for CSI-RS, in particular CSI-RS for a partial channel, the parameter Pc is associated to, e.g. a horizontal partial channel. It may be considered that the power boost indication is based on and/or takes into account a non-ideal beamforming gain, e.g. in form of an offset value, which may be a constant offset, e.g. added into parameter Pc. Such an offset value may generally be a pre-defined value and/or constant, and/or may be provided from a memory. It may be pre-determined, e.g. based on simulations and/or experiments, e.g. with the antenna arrangement. Generally, a power boost indicator parameter may represent a ration of less than 1 (indicating the CSI-RS is more powerful than the PDSCH, or 1 or more than 1). The parameter and/or ratio may be dependent on operational conditions, e.g. beam-forming, etc., as outlined herein.

The CSI-RS may be separated in partial channels and/or CSI-RS for partial channels and/or separate and/or orthogonal dimensions, e.g. CSI-RSH and CSI-RSV (or, in other words, a vertical and a horizontal component, which may be defined in regards to the arrangement of the antenna array used). The CSI-RS for the partial channels may be arranged to not reflect the full channel conditions, e.g. because the number of CSI-RS components/partial channels is lower than the number of antenna elements used for transmission.

This will hence indicate to the UE that the received power on the CSI-RS_{H} is less than what will be used for data transmission and hence the UE should consider this when choosing rank.

This power boost indication may for example be done by utilizing the parameter P_{C}, which indicates the ratio of PDSCH Energy Per Resource Element (EPRE) to CSI-RS EPRE. In one embodiment, the power boost indicator parameter may be defined as P_{C}=20/log 10( [symbol] ᵥ) [dB] for CSI-RS_{H} where P_{C} is assumed to specified in dB.

Hence, from this the UE can be expected to compensate for that the power of the transmitted data is assumed to be boosted by 20*log 10( [symbol] ᵥ) [dB] corresponding to the ideal beamforming gain from [symbol] ᵥ antennas. The actual vertical beamforming gain that is achievable will probably be smaller than the ideal beamforming gain due to straddling loss and grid-of-beams quantization in the precoder codebook. Therefore, in another embodiment, the parameter Pc may be set as P_{C}=20*log 10( [symbol] ᵥ)−x_{offset,H} [dB] where the purpose of x_{offset,H} is to reflect a non-ideal beamforming gain given that the transmitted power per antenna row is constant.

In another embodiment the parameter may be set to P_{C}=10*log 10( [symbol] ᵥ)−x_{offset,H} [dB], e.g., reflecting an assumption that the total transmitted antenna power is constant, such that this Pc may more accurately reflect the non ideal beamforming gain.

In one embodiment, x_{offset,H}=3 dB.

In another embodiment, Pc may be set to P_{C}=20*log 10( [symbol] ᵥ)−x_{offset,H}+P_{C}′ [dB] where P_{C}′ reflects that the system's P_{C} value when the system operates without using the approach presented.

The full channel CQI may be reconstructed from CQI_{V} and CQI_{H} by the network node or eNodeB, which may be adapted accordingly and/or comprise a correspondingly adapted CSI reconstructing module. The CQI reported back by the UE is an index indicating a desired MCS. However, this MCS is decided by the UE based upon an estimated SINR value. Thus, the CQI may be viewed as a quantized SINR report. Exactly how this mapping from SINR to CQI is done depends on the UE implementation. However, the network node or eNodeB may utilize and/or comprise a common SINR reference table in order to estimate a CQI value to a SINR value, i.e. estimate SINR_{V} and SINR_{H} based CQI_{V} and CQI_{H}. The network node may be adapted accordingly and/or comprise a corresponding estimating module.

However, as previously stated, the UE will create CQI_{V} and CQI_{H} without taking the two dimensional beamforming gain into account. Hence, it may be advantageous to correct also CQI_{V} and CQI_{H}. In one embodiment this is done by utilizing the parameter P_{C}, which indicates the ratio of PDSCH Energy Per Resource Element (EPRE) to CSI-RS EPRE. For CSI-RS_{H} the same approach as above may be used, hence e.g. P_{C}=20 log 10( [symbol] ᵥ)−x_{offset,H} [dB]. This will allow obtaining both correction on the CQI_{H} as well as RI_{H}. In order to also correct CQI_{V}, a parameter P_{C}=20*log 10( [symbol] ₖ)−x_{offset,V} may be used when configuring CSI-RS_{V} (e.g., transmitting such a parameter Pc to the terminal or UE as part of the power boost indication). Another option would be to use P_{C}=20*log 10( [symbol] ᵥ)−x_{offset,H} also for CSI-RS_{V} and then compensate the SINR_{V} at the eNodeB side such that SINR′_{V}=SINR_{V}−(20*log 10( [symbol] ᵥ)−x_{offset,H})+(20*log 10( [symbol] ₖ)−x_{offset,V}).

Based on the above, the precoder for the full channel matrix, W=W_{H} [symbol] W_{V}, as well as rank for the full channel matrix, RI=RI_{H} may be estimated and/or determined, e.g. by the network node, which may be correspondingly adapted, or a correspondingly adapted CSI reconstructing module. SINR_{V} and SINR_{H} compensating for the two dimensional beamforming gain for the full channel matrix may also be determined/estimated/reconstructed.

To provide a full CSI report for the full channel matrix, CQI for the full channel matrix is to be determined, e.g. by the network node, which may be correspondingly adapted, and/or by a correspondingly adapted CSI reconstructing module. In one embodiment, this is done by estimating the SINR for the full channel matrix as SINR=\sqrt{SINR_{H}·SINR_{V}} where SINR_{V} and SINR_{H} are assumed to be specified in linear scale (i.e. not dB). In another embodiment, estimating SINR=(SINR_{H}+SINR_{V})/2 may be performed. In yet another embodiment, SINR may be estimated as SINR=α·SINR_{H}·SINR_{V}/σ² where α is some constant and σ² is the estimated noise and/or interference level. Based on the estimated SINR, SINR may be mapped back to CQI.

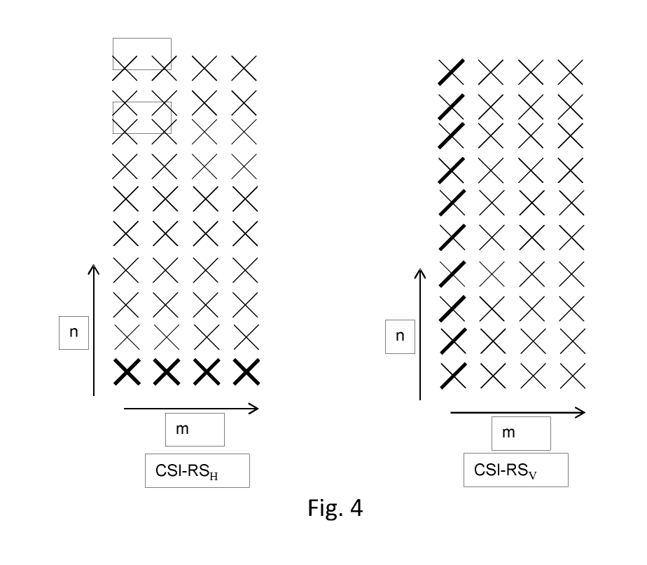

In another embodiment, the above described framework may be applied to a 10×4 antenna as illustrated in FIG. 4. CSI-RS_{H} can hence be configured in the same manner as in the previous embodiment. For CSI-RS_{V} there does however not exist a codebook in the LTE release 12 standard that has 10 ports. Accordingly, an association or connection of one port to one antenna element as in the previous embodiment is not available. However, in one embodiment the CSI-RS_{V} is configured corresponding to 8 ports, which is supported by LTE release 10, and these 8 ports are virtualized onto the 10 antenna subelements by some virtualization matrix W_{10×8} such that c_{10×1}′=W_{10×8}c_{8×1}. Here it is assumed that c_{8×1} corresponds to the 8 ports CSI-RS_{V}, W_{10×8} corresponds to a virtualization matrix of size 10×8 and c_{10×1}′ corresponds to a 10-dimensional signal that is mapped to the 10 antenna subelements of the antenna. Hence, by performing such a virtualization, 8 ports may be mapped to 10 antenna subelements.

Correcting the rank report (RI_{H}), CQI_{V} and CQI_{H} in the same manner as presented in previous embodiments may be performed. This will hence enable the network node or eNodeB to estimate CQI/RI/PMI for the full antenna array which was also described in previous embodiments. Generally, a network node may be adapted to map, map and/or comprise a mapping module for mapping, CSI ports to antenna subelements, e.g. to provide a virtual number of ports, which may be supported by and/or in line with a standard, e.g. LTE.

FIG. 1 shows an illustration of a two-dimensional antenna array of cross-polarized antenna elements ( [symbol] ₚ=2), with [symbol] ₖ=4 horizontal antenna elements and [symbol] ᵥ=0.9 vertical antenna elements, assuming one antenna element corresponds to one antenna port.

FIG. 2 shows a transmission structure of precoded spatial multiplexing mode in LTE.

FIG. 3 shows an 8×4 antenna with corresponding CSI-RSs.

FIG. 4 shows an 10×4 antenna with corresponding CSI-RSs.

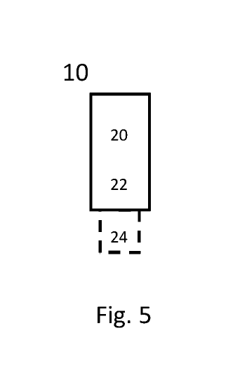

FIG. 5 schematically shows a terminal 10, which may be implemented in this example as a user equipment. Terminal 10 comprises control circuitry 20, which may comprise a controller connected to a memory. A receiving module and/or transmitting module and/or control or processing module and/or CIS receiving module and/or scheduling module, may be implemented in and/or executable by, the control circuitry 20, in particular as module in the controller. Terminal 10 also comprises radio circuitry 22 providing receiving and transmitting or transceiving functionality, the radio circuitry 22 connected or connectable to the control circuitry. An antenna circuitry 24 of the terminal 10 is connected or connectable to the radio circuitry 22 to collect or send and/or amplify signals. Radio circuitry 22 and the control circuitry 20 controlling it are configured for cellular communication with a network on a first cell/carrier and a second cell/carrier, in particular utilizing E-UTRAN/LTE resources as described herein. The terminal 10 may be adapted to carry out any of the methods for operating a terminal disclosed herein; in particular, it may comprise corresponding circuitry, e.g. control circuitry. Modules of a terminal as described herein may be implemented in software and/or hardware and/or firmware in corresponding circuitry.

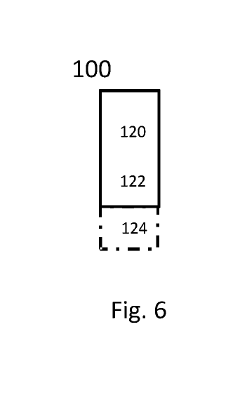

FIG. 6 schematically show a network node or base station 100, which in particular may be an eNodeB. Network node 100 comprises control circuitry 120, which may comprise a controller connected to a memory. A receiving module and/or transmitting module and/or control or processing module and/or scheduling module and/or CIS receiving module, may be implemented in and/or executable by the control circuitry 120. The control circuitry is connected to control radio circuitry 122 of the network node 100, which provides receiver and transmitter and/or transceiver functionality. An antenna circuitry 124 may be connected or connectable to radio circuitry 122 for signal reception or transmittance and/or amplification. The network node 100 may be adapted to carry out any of the methods for operating a network node disclosed herein; in particular, it may comprise corresponding circuitry, e.g. control circuitry. Modules of a network node as described herein may be implemented in software and/or hardware and/or firmware in corresponding circuitry.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may involve one or more than one terminal connected to a wireless communication network and/or more than one node of a wireless communication network and/or in a wireless communication network. It may be envisioned that a node in or for communication, and/or in, of or for a wireless communication network is adapted for communication utilizing one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes and/or terminals of the communication. It may, e.g., include address data referring to a node or terminal of the communication and/or data pertaining to the transmission mode and/or spectral configuration and/or frequency and/or coding and/or timing and/or bandwidth as data pertaining to the process of communication or transmission, e.g. in a header. Each node or terminal involved in communication may comprise radio circuitry and/or control circuitry and/or antenna circuitry, which may be arranged to utilize and/or implement one or more than one radio access technologies. Radio circuitry of a node or terminal may generally be adapted for the transmission and/or reception of radio waves, and in particular may comprise a corresponding transmitter and/or receiver and/or transceiver, which may be connected or connectable to antenna circuitry and/or control circuitry. Control circuitry of a node or terminal may comprise a controller and/or memory arranged to be accessible for the controller for read and/or write access. The controller may be arranged to control the communication and/or the radio circuitry and/or provide additional services. Circuitry of a node or terminal, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered.

A node of a wireless communication network may be implemented as a terminal and/or user equipment and/or base station and/or relay node and/or any device generally adapted for communication in a wireless communication network, in particular cellular communication.

A cellular network may comprise a network node, in particular a radio network node, which may be connected or connectable to a core network, e.g. a core network with an evolved network core, e.g. according to LTE. A network node may e.g. be a base station. The connection between the network node and the core network/network core may be at least partly based on a cable/landline connection. Operation and/or communication and/or exchange of signals involving part of the core network, in particular layers above a base station or eNB, and/or via a predefined cell structure provided by a base station or eNB, may be considered to be of cellular nature or be called cellular operation.

A terminal may be implemented as a user equipment. A terminal or a user equipment (UE) may generally be a device configured for wireless device-to-device communication and/or a terminal for a wireless and/or cellular network, in particular a mobile terminal, for example a mobile phone, smart phone, tablet, PDA, etc. A user equipment or terminal may be a node of or for a wireless communication network as described herein, e.g. if it takes over some control and/or relay functionality for another terminal or node. It may be envisioned that terminal or a user equipment is adapted for one or more RATs, in particular LTE/E-UTRA. A terminal or user equipment may generally be proximity services (ProSe) enabled, which may mean it is D2D capable or enabled. It may be considered that a terminal or user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. It may be considered that a terminal or user equipment is configured to be a terminal or user equipment adapted for LTE/E-UTRAN.

A base station may be any kind of base station of a wireless and/or cellular network adapted to serve one or more terminals or user equipments. It may be considered that a base station is a node or network node of a wireless communication network. A network node or base station may be adapted to provide and/or define and/or to serve one or more cells of the network and/or to allocate frequency and/or time resources for communication to one or more nodes or terminals of a network. Generally, any node adapted to provide such functionality may be considered a base station. It may be considered that a base station or more generally a network node, in particular a radio network node, comprises radio circuitry and/or control circuitry for wireless communication. It may be envisioned that a base station or network node is adapted for one or more RATs, in particular LTE/E-UTRA. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A base station may be arranged to be a node of a wireless communication network, in particular configured for and/or to enable and/or to facilitate and/or to participate in cellular communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station and/or be Proximity Service enabled. An eNodeB (eNB) may be envisioned as an example of a base station, e.g. according to an LTE standard. A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a coordinating node and/or to allocate resources in particular for cellular communication between two nodes or terminals of a wireless communication network, in particular two user equipments.

It may be considered for cellular communication there is provided at least one uplink (UL) connection and/or channel and/or carrier and at least one downlink (DL) connection and/or channel and/or carrier, e.g. via and/or defining a cell, which may be provided by a network node, in particular a base station or eNodeB. An uplink direction may refer to a data transfer direction from a terminal to a network node, e.g. base station and/or relay station. A downlink direction may refer to a data transfer direction from a network node, e.g. base station and/or relay node, to a terminal. UL and DL may be associated to different frequency resources, e.g. carriers and/or spectral bands. A cell may comprise at least one uplink carrier and at least one downlink carrier, which may have different frequency bands. A network node, e.g. a base station or eNodeB, may be adapted to provide and/or define and/or control one or more cells, e.g. a PCell and/or a LA cell.

A network node, in particular a base station, and/or a terminal, in particular a UE, may be adapted for communication in spectral bands (frequency bands) licensed and/or defined for LTE. In addition, a network node, in particular a base station/eNB, and/or a terminal, in particular a UE, may be adapted for communication in freely available and/or unlicensed/LTE-unlicensed spectral bands (frequency bands), e.g. around 5 GHz.

Configuring a terminal or wireless device or node may involve instructing and/or causing the wireless device or node to change its configuration, e.g. at least one setting and/or register entry and/or operational mode. A terminal or wireless device or node may be adapted to configure itself, e.g. according to information or data in a memory of the terminal or wireless device. Configuring a node or terminal or wireless device by another device or node or a network may refer to and/or comprise transmitting information and/or data and/or instructions to the wireless device or node by the other device or node or the network, e.g. allocation data and/or scheduling data and/or scheduling grants.

A wireless communication network may comprise a radio access network (RAN), which may be adapted to perform according to one or more standards, in particular LTE, and/or radio access technologies (RAT).

A network device or node and/or a wireless device may be or comprise a software/program arrangement arranged to be executable by a hardware device, e.g. control circuitry, and/or storable in a memory, which may provide the described functionality and/or corresponding control functionality.

A cellular network or mobile or wireless communication network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

Resources or communication resources or radio resources may generally be frequency and/or time resources (which may be called time/frequency resources). Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information. Allocated resources may in particular refer to UL resources, e.g. UL resources for a first wireless device to transmit to and/or for a second wireless device. Transmitting on allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated. A network or a node of a network, e.g. an allocation or network node, may be adapted to determine and/or transmit corresponding allocation data indicating release or de-allocation of resources to one or more wireless devices, in particular to a first wireless device. Resources may comprise for example one or more resource elements and/or resource blocks.

Allocation data may be considered to be data indicating and/or granting resources allocated by the controlling or allocation node, in particular data identifying or indicating which resources are reserved or allocated for communication for a wireless device and/or which resources a wireless device may use for communication and/or data indicating a resource grant or release. A grant or resource or scheduling grant may be considered to be one example of allocation data. Allocation data may in particular comprise information and/or instruction regarding a configuration and/or for configuring a terminal, e.g. for HARQ bundling and/or which HARQ bundling method to perform and/or how to perform HARQ bundling. Such information may comprise e.g. information about which carriers (and/or respective HARQ feedback) to bundle, bundle size, method to bundle (e.g. which operations to perform, e.g. logical operations), etc., in particular information pertaining to and/or indicating the embodiments and methods described herein. It may be considered that an allocation node or network node is adapted to transmit allocation data directly to a node or wireless device and/or indirectly, e.g. via a relay node and/or another node or base station. Allocation data may comprise control data and/or be part of or form a message, in particular according to a pre-defined format, for example a DCI format, which may be defined in a standard, e.g. LTE. Allocation data may comprise configuration data, which may comprise instruction to configure and/or set a user equipment for a specific operation mode, e.g. in regards to the use of receiver and/or transmitter and/or transceiver and/or use of transmission (e.g. TM) and/or reception mode, and/or may comprise scheduling data, e.g. granting resources and/or indicating resources to be used for transmission and/or reception. A scheduling assignment may be considered to represent scheduling data and/or be seen as an example of allocation data. A scheduling assignment may in particular refer to and/or indicate resources to be used for communication or operation.

A terminal or user equipment may generally be operable with and/or connected or connectable to and/or comprise an antenna arrangement or antenna array, in particular a 2-d array, adapted for MIMO operation and/or comprising a plurality of individually controllable antenna elements. Generally, a terminal or UE may be a terminal or UE for or in a wireless communication network.

A network node may generally be operable with and/or connected or connectable to and/or comprise an antenna arrangement or antenna array, in particular a 2-d array, adapted for MIMO operation and/or comprising a plurality of individually controllable antenna elements. Generally, a network node, in particular an eNodeB, may be a network node for or in a wireless communication network.

A terminal or user equipment (UE) may generally be adapted to receive, and/or receive and/or comprise a receiving module for receiving, CSI-RS signaling, e.g. from a network node or network. The terminal or user equipment may be adapted to provide (e.g., by transmitting), and/or provide and/or comprise a feedback module for providing, CSI feedback, in particular CSI feedback comprising RI and/or PMI and/or CQI. A network node, e.g. an eNodeB, may be adapted to provide (e.g. by transmitting), and/or provide and/or comprise a CSI providing module, CSI-RS signaling, e.g. to one or more than one terminals or UEs. It may be considered that a network node is adapted to receive, and/or receives and/or comprises a feedback receiving module, for receiving CSI feedback, e.g. from one or more terminals or UEs.

Generally, determining and/or reconstructing CSI or CSI feedback, e.g. for a full channel, may comprise estimating one or more than one values and/or parameters.

Providing CSI-RS signaling may comprise utilizing a multi-antenna array, in particular a 2D antenna array. Providing the signaling may be based on a mapping of antenna elements to ports and/or comprise antenna virtualization, wherein a number of (physical) antenna elements are mapped to a number of virtual antenna elements, wherein the number of (physical) antenna elements may be larger than the number of virtual antenna elements. A port may generally comprise a mapping for signals (in particular, CSI-RS signaling) to antenna elements, which may be physical or virtual elements. The CSI-RS signaling respectively a corresponding CSI process or feedback may pertain to two separate and/or independent dimensions, e.g. horizontal and vertical.

Some useful abbreviations include:

| Abbreviation | Explanation |
|---|---|
| CCA | Clear Channel Assessment |
| DCI | Downlink Control Information |
| DL | Downlink |
| DMRS | Demodulation Reference Signals |
| eNB | evolved NodeB, base station |
| TTI | Transmission-Time Interval |
| UE | User Equipment |
| UL | Uplink |
| LA | Licensed Assisted |
| LA | Licensed Assisted Access |
| DRS | Discovery Reference Signal |
| SCell | Secondary Cell |
| SRS | Sounding Reference Signal |
| LBT | Listen-before-talk |
| PCFICH | Physical Control Format Indicator Channel |
| PDCCH | Physical Downlink Control Channel |
| PUSCH | Physical Uplink Shared Channel |
| PUCCH | Physical Uplink Control Channel |
| RRM | Radio Resource Management |
| CIS | Transmission Confirmation Signal |
| 3GPP | 3^{rd} Generation Partnership Project |
| Ack/Nack | Acknowledgment/Non-Acknowledgement, also A/N |
| AP | Access point |
| B1, | Bandwidth of signals, in particular carrier |
| B2, . . . Bn | bandwidth Bn assigned to corresponding carrier |
| | or frequency f1, f2, . . . , fn |
| BER/BLER | Bit Error Rate, BLock Error Rate; |
| BS | Base Station |
| CA | Carrier Aggregation |
| CoMP | Coordinated Multiple Point Transmission and |
| | Reception |
| CQI | Channel Quality Information |
| CRS | Cell-specific Reference Signal |
| CSI | Channel State Information |
| CSI-RS | CSI reference signal |
| D2D | Device-to-device |
| DL | Downlink |
| DL | Downlink; generally referring to transmission of |
| | data to a node/into a direction further away from |
| | network core (physically and/or logically); in |
| | particular from a base station or eNodeB |
| | terminal; more generally, may refer to |
| | transmissions received by a terminal or node |
| | (e.g. in a D2D environment); often uses specified |
| | spectrum/bandwidth different from UL (e.g. LTE) |
| eNB | evolved NodeB; a form of base station, also |
| | called eNodeB |
| EPDCCH | Enhanced Physical DL Control CHannel |
| E-UTRA/N | Evolved UMTS Terrestrial Radio Access/Network, an |
| | example of a RAT |
| f1, f2, | carriers/carrier frequencies; different numbers |
| f3, . . . , | may indicate that the referenced carriers/frequencies |
| fn | are different |
| f1_UL, . . . , | Carrier for Uplink/in Uplink frequency or band |
| fn_UL | |
| f1_DL, . . . , | Carrier for Downlink/in Downlink frequency or |
| fn_DL | band |
| FDD | Frequency Division Duplexing |
| ID | Identity |
| L1 | Layer 1 |
| L2 | Layer 2 |
| HARQ | Hybrid Automatic Repeat reQuest |
| LTE | Long Term Evolution, a telecommunications |
| | standard |
| MAC | Medium Access Control |
| MBSFN | Multiple Broadcast Single Frequency Network |
| MCS | Modulation and Coding Scheme |
| MDT | Minimisation of Drive Test |
| NW | Network |
| OFDM | Orthogonal Frequency Division Multiplexing |
| O&M | Operational and Maintenance |
| OSS | Operational Support Systems |
| PC | Power Control |
| PDCCH | Physical DL Control Channel |
| PH | Power Headroom |
| PHR | Power Headroom Report |
| PMI | Precoding Matrix Indicator |
| PRB | Physical Resource Block |
| PSS | Primary Synchronization Signal |
| PUSCH | Physical Uplink Shared Channel |
| R1, | Resources, in particular time-frequency |
| R2, . . . , | resources, in particular assigned to |
| Rn | corresponding carrier f1, f2, . . . , fn |
| RA | Random Access |
| RACH | Random Access CHannel |
| RAT | Radio Access Technology |
| RE | Resource Element |
| RB | Resource Block |
| RI | Rank Indicator |
| RRC | Radio Resource Control |
| RRH | Remote radio head |
| RRM | Radio Resource Management |
| RRU | Remote radio unit |
| RSRQ | Reference signal received quality |
| RSRP | Reference signal received power |
| RSSI | Received signal strength indicator |
| RX | reception/receiver, reception-related |
| SA | Scheduling Assignment |
| SINR/SNR | Signal-to-Noise-and-Interference Ratio; |
| | Signal-to-Noise Ratio |
| SFN | Single Frequency Network |
| SON | Self Organizing Network |
| SR | Scheduling Request |
| SSS | Secondary Synchronization Signal |
| TPC | Transmit Power Control |
| TX | transmission/transmitter, transmission-related |
| TDD | Time Division Duplexing |
| UE | User Equipment |
| UL | Uplink; generally referring to transmission of |
| | data to a node/into a direction closer to a |
| | network core (physically and/or logically); in |
| | particular from a D2D enabled node or UE to a |
| | base station or eNodeB; in the context of D2D, it |
| | may refer to the spectrum/bandwidth utilized for |
| | transmitting in D2D, which may be the same used |
| | for UL communication to a eNB in cellular |
| | communication; in some D2D variants, transmission |
| | by all devices involved in D2D communication may |
| | in some variants generally be in UL |
| | spectrum/bandwidth/carrier/frequency; generally, |
| | UL may refer to transmission by a terminal (e.g. |
| | to a network or network node or another terminal, |
| | for example in a D2D context). |

These and other abbreviations may be used according to LTE standard definitions.

1-7. (canceled)

8. A method for operating a network node for a wireless communication network, the method comprising:
providing CSI-RS signaling; and
signaling a power boost indication for the CSI-RS signaling.

9. A network node for a wireless communication network, the network node being adapted for providing CSI-RS signaling, the network node further being adapted for a boost indication module for signaling a power boost indication for the CSI-RS signaling.

10. A network node for a wireless communication network, the network node being adapted to configure a terminal with a power boost indication for CSI-RS signaling provided by the network node.

11. A method for operating a network node for a wireless communication network, the method comprising:
configuring a terminal with a power boost indication for CSI-RS signaling provided by the network node.

12. A method for operating a terminal for a wireless communication network, the method comprising:
determining CSI-RS feedback based on a power boost indication for the CSI-RS signaling received from and/or configured by a network node.

13. A terminal for a wireless communication network, the terminal being configured to determine CSI-RS feedback based on a power boost indication for the CSI-RS signaling received from and/or configured by a network node.

14. A non-transitory computer-readable storage medium adapted to store instructions executable by control circuitry, the instructions being configured to cause the control circuitry to carry out the method of claim 8 when executed by the control circuitry.
